(19) United States
(12) Patent Application Publication
(10) Pub. No.: US 2009/0311520 A1
(43) Pub. Date: Dec. 17, 2009

(54) MULTI-LAYER ADHESIVE FILM FOR DIE STACKING

(76) Inventor: Hwail Jin, Cumming, GA (US)

Correspondence Address: Henkel Corporation, 10 Finderne Avenue, Bridgewater, NJ, 08807, US

(21) Appl. No.: 12/279,932

(22) PCT Filed: Dec. 15, 2005
(86) PCT No.: PCT/US05/46390

§ 371 Date: Dec. 10, 2008

(51) Int. Cl. B32B 25/00; B32B 5/00; B32B 27/38; B32B 27/00

(52) U.S. Cl. 428/336; 428/411.1; 428/413; 428/704; 428/473.5; 428/500

(57) ABSTRACT

An adhesive film for die stacking at least two neighboring semiconductor dies containing metal wire bonds, comprises (a) Layer-1 adhesive, which comes in contact with the first semiconductor die and is capable of flowing around the metal wire bonds of that first semiconductor die at die attach temperatures, and (b) Layer-2 adhesive, which comes in contact with the second semiconductor die, in which Layer-2 adhesive comprises 30-85 weight % thermoplastic rubber with a glass transition temperature of less than 25° C. and a weight average molecular weight of greater than 100,000.

### FIELD OF THE INVENTION

This invention relates to a multi-layer adhesive film comprising a combination of thermoplastic rubbers and thermoset resins, particularly for use as an adhesive film for die stacking within semiconductor packages.

### BACKGROUND OF THE INVENTION

Recent advancements in semiconductor packaging have led to the development of the “stacked” package, in which two or more semiconductor dies are mounted on top of one another within a single semiconductor package. This stacking of dies enables increased functionality in a small footprint, allowing for downsizing of the overall semiconductor package. Typically, an adhesive paste or film is used between the two semiconductor dies to ensure package integrity during wirebonding, molding, solder reflow, and end use.

There are various methods of assembling a package in a stacked configuration. Each die contains a number of electrical terminals, from which metal, usually gold, wires extend to electrical terminals on a substrate. In a stacked package the wire bonds from one die must avoid contact with and damage to the neighboring dies. In one method the die have consecutively reduced size (bottom to top) such that the wire bonds of the lower die are outside the area of any upper die. This pyramid configuration has limitations in that all of the wire bonds must be made on the outside periphery of the die and functionality is reduced on each subsequently smaller die. Another assembly method involves the use of a spacer between the stacked dies to prevent contact between the wire bond of the lower die and the bottom surface of the next die. This allows each stacked die to be the same size, but limits vertical downsizing of the package.

It is known to use an insulation layer and an adhesion layer between two dies in a stacked configuration in order to provide adhesion between the two dies and insulation between the wire bonds of the lower die and the bottom surface of the upper die. However, if the insulation layer flows too readily during the attach of the upper die, the wire bonds of the bottom die can penetrate the insulation layer, leading to contact with the upper die, wire bond damage, and possible shorting. Therefore, it is critical that the insulation layer have a high enough viscosity at die attach temperatures to prevent this penetration.

Moreover, the continuing trend within the semiconductor industry toward thinner die presents special challenges in the construction of stacked packages. In one construction method, the insulation layer is laminated to a wafer prior to the dicing operation. If a thin wafer, typically less than 0.127 mm thick, is used, the film must be laminated at a low temperature, typically 40° C. to 50° C., to prevent warpage of the wafer, which can result due to a differential in the coefficient of thermal expansion between the wafer and film. The insulation layer must soften sufficiently to wet-out the surface of the wafer and properly adhere at these low lamination temperatures.

The insulation layer must also resist plastic deformation at die attach temperatures, typically around 100° C. to 150° C., so that it can insulate the top die from the wires of the bottom die. These contradictory requirements of wet out at low lamination temperatures and resistance to plastic deformation at die attach temperatures can be difficult to achieve.

In addition, the adhesive layer in contact with the lower die must have a low viscosity at die attach temperatures. If the viscosity is too high the adhesive will not flow adequately around the wire bonds and small air pockets, or voids, will be trapped. The air in these voids is then likely to expand during subsequent processing steps such as solder reflow, potentially causing wire bonds to break and fail.

### SUMMARY OF THE INVENTION

This invention is an adhesive film for disposition between two neighboring semiconductor dies, typically those that contain metal bonding wires, in a stacked configuration. As used in this specification and claims, such a configuration will be referred to as a die stack or die stacking. Thus, this invention is an adhesive film for die stacking at least two neighboring semiconductor dies containing metal wire bonds, the film comprising (a) Layer-1 adhesive, which comes in contact with the first semiconductor die and is capable of flowing around the metal wire bonds of that first semiconductor die at die attach temperatures, and (b) Layer-2 adhesive, which comes in contact with the second semiconductor die, in which Layer-2 adhesive comprises 30-85 weight % thermoplastic rubber with a glass transition temperature of less than 25° C. and a weight average molecular weight of greater than 100,000.

Layer-1 must have adequate flow around the wire bonds at die attach temperatures, which are typically in the range of 100 to 150° C. The adhesive must be able to fully encapsulate the wire bonds without the presence of voids, providing sufficient protection for subsequent processing steps. However, it must not have excessive flow as that would lead to outflow of the adhesive from between the dies. The composition of Layer-1 should be tailored to the particular application and manufacturing environment, but a viscosity range between 100 P and 100,000 P at die attach temperatures is typically required to provide adequate flow for wire encapsulation while avoiding outflow from between the dies.

Layer-2 must soften and wet out well enough to enable lamination at low temperatures, typically around 40° C. to 50° C. To achieve this performance, Layer-2 must comprise between 30-85 weight % thermoplastic rubber with a glass. transition temperature (Tg) below 25° C. The low Tg allows the film to soften and adhere to the wafer at low lamination temperatures. In addition, the thermoplastic rubber must have a weight average molecular weight (Mw) of greater than 100,000 so that it will resist plastic deformation upon contact with the wires of the first die. In this way Layer-2 will provide the desired insulation between the wires of the first die and the bottom surface of the second die, preventing shorts and wire bond damage.

The viscosity of Layer-1 must be lower than the viscosity of Layer-2 at die attach temperatures, typically 100 to 150° C. If the viscosity of Layer-2 were lower than Layer-1 the temperature and pressure required to enable the Layer-1 adhesive to flow around the wire bonds would cause the Layer-2 adhesive to either flow outside of the bonding area, allow the wire bonds to penetrate through to the second die, or both.

Layer-1 must be at least 15 μm thick so that there is enough adhesive to flow around the wire bonds and encapsulate them. If Layer-1 is thinner than 15 μm the film adhesive cannot fully fill in under the wire and the wire on the first die can be damaged.

### DETAILED DESCRIPTION OF THE INVENTION

Layer-1 can be any adhesive composition that flows well enough to completely encapsulate the wires of the first die without entrapping air, but which does not flow out of the space between the two dies, at die attach temperatures. A composition with a viscosity of 100 to 100,000 P at die attach temperatures, typically 100 to 150° C., will provide the required flow. Layer-2 comprises between 30-85 weight % thermoplastic rubber with a Tg below 25° C. and a Mw above 100,000. The adhesive compositions must be capable of bonding to the surface of the die, and of being attached to one another or to a third film or carrier interposed between the two layers. The viscosity of Layer-1 must be lower than the viscosity of Layer-2 at the die attach temperature.

Although any adhesives that meet the above criteria can be used, one suitable formulation for either Layer-1 or Layer-2 will contain (a) thermoplastic rubber, (b) thermoset resin, (c) curing agent, and (d) filler. Typical weight percent ranges for this embodiment are 30-85 weight % thermoplastic rubber, 15-70 weight % thermoset resin, 0.05-40 weight % curing agent, and 0.1-30 weight % filler. A curing agent is any material or combination of materials that initiate, propagate, or accelerate cure of the adhesive and includes accelerators, catalysts, initiators, and hardeners.

In a further embodiment of Layer-1 or Layer-2, the thermoset resin will be an epoxy resin or a solid epoxy, such as bisphenol A epoxy, bisphenol F epoxy, phenol novolac epoxy or cresol novolac epoxy. Such epoxies are commercially available from Shell Chemicals and Dainippon Ink and Chemicals, Inc.

In a further embodiment of Layer-1 or Layer-2, a combination of thermoset resins may be used. In addition to epoxies, other thermoset resins that are suitable for Layer-1 or Layer-2 include maleimides, acrylates, vinyl ethers, and poly(butadienes) that have at least one double bond in a molecule.

Examples of suitable maleimide resins include, but are not limited to, those commercially available from Dainippon Ink and Chemical, Inc. Other suitable maleimide resins are selected from the group consisting of

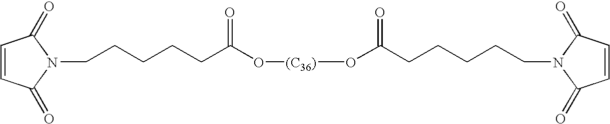

in which C₃₆ represents a linear or branched chain (with or without cyclic moieties) of 36 carbon atoms;

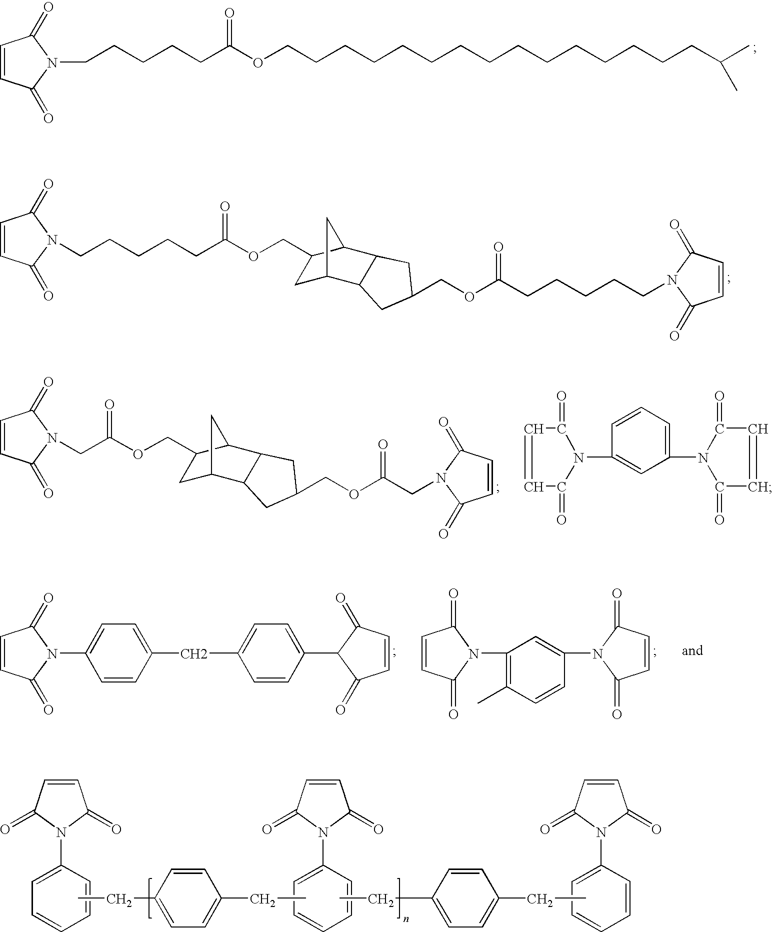

in which n is 1 to 5.

Examples of suitable acrylate resins include, but are not limited to, butyl (meth)acrylate, isobutyl (meth)acrylate, 2-ethyl hexyl (meth)acrylate, isodecyl (meth)acrylate, n-lauryl (meth)acrylate, alkyl (meth)acrylate, tridecyl (meth)acrylate, n-stearyl (meth)acrylate, cyclohexyl(meth)acrylate, tetrahydrofurfuryl(meth)acrylate, 2-phenoxy ethyl(meth)acrylate, isobornyl(meth)acrylate, 1,4-butanediol di(meth)acrylate, 1.6 hexanediol di(meth)acrylate, 1,9-nonandiol di(meth)acrylate, perfluorooctylethyl (meth)acrylate, 1,10 decandiol di(meth)acrylate, nonylphenol polypropoxylate (meth)acrylate, and polypentoxylate tetrahydrofurfuryl acrylate, available from Kyoeisha Chemical Co., LTD; polybutadiene urethane dimethacrylate (CN302, NTX6513) and polybutadiene dimethacrylate (CN301, NTX6039, PRO6270) available from Sartomer Company, Inc; polycarbonate urethane diacrylate (ArtResin UN9200A) available from Negami Chemical Industries Co., LTD; acrylated aliphatic urethane oligomers (Ebecryl 230, 264, 265, 270,284, 4830, 4833, 4834, 4835, 4866, 4881, 4883, 8402, 8800-20R, 8803, 8804) available from Radcure Specialities, Inc; polyester acrylate oligomers (Ebecryl 657, 770, 810, 830, 1657, 1810, 1830) available from Radcure Specialities, Inc.; and epoxy acrylate resins (CN104, 111, 112, 115, 116, 117, 118, 119, 120, 124, 136) available from Sartomer Company, Inc.

In one embodiment the acrylate resins are selected from the group consisting of isobornyl acrylate, isobornyl methacrylate, lauryl acrylate, lauryl methacrylate, poly(butadiene) with acrylate functionality and poly(butadiene) with methacrylate functionality.

Examples of suitable vinyl ether resins include, but are not limited to, cyclohenanedimethanol divinylether, dodecylvinylether, cyclohexyl vinylether, 2-ethylhexyl vinylether, dipropyleneglycol divinylether, hexanediol divinylether, octadecylvinylether, and butandiol divinylether available from International Speciality Products (ISP); Vectomer 4010, 4020, 4030, 4040, 4051, 4210, 4220, 4230, 4060, 5015 available from Sigma-Aldrich, Inc.

Examples of suitable poly(butadiene) resins include poly(butadienes), epoxidized poly(butadienes), maleic poly(butadienes), acrylated poly(butadienes), butadiene-styrene copolymers, and butadiene-acrylonitrile copolymers. Commercially available materials include homopolymer butadiene (Ricon130, 131, 134, 142, 150, 152, 153, 154, 156, 157, P30D) available from Sartomer Company, Inc; random copolymer of butadiene and styrene (Ricon 100, 181, 184) available from Sartomer Company Inc.; maleinized poly(butadiene) (Ricon 130MA8, 130MA13, 130MA20, 131MA5, 131MA10, 131MA17, 131MA20, 156MA17) available from Sartomer Company, Inc.; acrylated poly(butadienes) (CN302, NTX6513, CN301, NTX6039, PRO6270, Ricacryl 3100, Ricacryl 3500) available from Sartomer Inc.; epoxydized poly(butadienes) (Polybd 600, 605) available from Sartomer Company. Inc. and Epolead PB3600 available from Daicel Chemical Industries, Ltd; and acrylonitrile and butadiene copolymers (Hycar CTBN series, ATBN series, VTBN series and ETBN series) available from Hanse Chemical.

For either Layer-1 or Layer-2, the thermoplastic rubber will be present in an amount of 30-85 weight %; suitable thermoplastic rubbers include carboxy terminated butadiene-nitrile (CTBN)/epoxy adduct, acrylate rubber, vinyl-terminated butadiene rubber, and nitrile butadiene rubber (NBR). The CTBN epoxy adduct consists of about 20-80 wt % CTBN and about 20-80 wt % diglycidyl ether bisphenol A: bisphenol A epoxy (DGEBA). CTBN will have a weight average molecular weight in the range of about 100 to 10,000 and DGEBA will have an equivalent weight (or weight per epoxy, g/epoxy) in the range of about 500 to 5,000. The final adduct will have an equivalent weight of about 500 to 5,000 g/epoxy and a melt viscosity at 150° C. of 5,000 to 100,000 cP. A variety of CTBN materials are available from Noveon Inc., and a variety of bisphenol A epoxy materials are available from Dainippon Ink and Chemicals, Inc., and Shell Chemicals. The NBR consists of acrylonitrile in the range of 20-50 wt % and butadiene in the range of 50-80 wt %, and has a glass transition temperature (Tg) from −40 to +20° C. and a weight average molecular weight (Mw) of 100,000 to 1,000,000. NBR rubbers of this type are commercially available from Zeon Corporation.

The curing agent of Layer-1 or Layer-2 will be present in an amount of 0.5 to 40 wt %; suitable curing agents include phenolics, aromatic diamines, dicyandiamides, peroxides, amines, imidizoles, tertiary amines, and polyamides. Suitable phenolics are commercially available from Schenectady international, Inc. Suitable aromatic diamines are primary diamines and include diaminodiphenyl sulfone and diaminodiphenyl methane, commercially available from Sigma-Aldrich Co. Suitable dicyandiamides are available from SKW Chemicals, Inc. Suitable polyamides are commercially available from Air Products and Chemicals, Inc. Suitable imidazoles are commercially available from Air Products and Chemicals, Inc. Suitable tertiary amines are available from Sigma-Aldrich Co. Suitable peroxides include benzoyl peroxide, tert-butyl peroxide, lauroyl peroxide, cumene hydroperoxide, cyclohexanone peroxide, butyl peroctoates and dicumyl peroxide. Additional curing agents that are suitable include and azo compounds, such as 2,2′-azobis(2-methyl-propanenitrile), 2,2′-azobis(2-methyl-butanenitrile), 4,4-azobis(4-cyanovaleric acid), 1,1′-azobis(cyclohexanecarbonitrile), and 2,2′-azobisisobutyronitrile.

The filler of Layer-1 or Layer-2 will have a particle size of 0.1 to 10 μm and will be present in an amount of 0.1 to 30 wt %. Filler selection will depend on the particular package configuration. The filler will be electrically non-conductive when the adhesive layer is in contact with the wire bonds. Examples of suitable nonconductive fillers include alumina, aluminum hydroxide, silica, vermiculite, mica, wollastonite, calcium carbonate, titania, sand, glass, barium sulfate, and halogenated ethylene polymers such as, tetrafluorotheylene, trifluoroethylene, vinylidene fluoride, vinyl fluoride, vinylidene chloride, and vinyl chloride.

Other additives, such as adhesion promoters, in types and amounts known in the art, may also be added.

### EXAMPLES

### Example 1

FILM A. Layer 1 (for adhesion to the first semiconductor chip) was prepared by mixing the following components in parts by weight (pbw) in sufficient methyl ethyl ketone (MEK) to make a paste:
10 pbw epoxy-modified CTBN
3.8 pbw cresol novolac epoxy
0.8 pbw aromatic diamine
0.08 pbw amine catalyst
0.2 pbw silane coupling agent
0.4 pbw silica filler

This paste was coated onto a 50 μm thick release-coated polyester film and dried at 100° C. for 5 minutes to make Film A, Layer 1 at 60 μm thickness. This film layer was tested for viscosity at 100° C., 120° C., and 150° C. using a parallel plate rheometer with 25 mm diameter, and a dynamic temperature ramp test at 10.0 rad/s and a ramp rate of 5.0° C./min.

Layer 2 (for adhesion to the second semiconductor chip) was prepared by mixing the following components in parts by weight (pbw) in sufficient MEK to make a paste:
8 pbw nitrile butadiene rubber with a Mw of 360,000 and a Tg of −24° C.
2 pbw 4,4′-bismaleimido-diphenyl methane
3 pbw the adduct of tricyclodecane-dimethanol and 3-isopropenyl-, -dimethylbenzyl isocyanate (m-TMI) having the structure

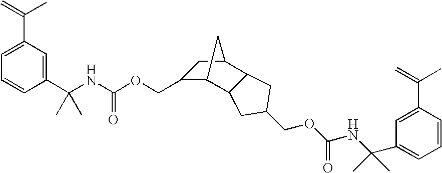

1.5 pbw vinyl-terminated butadiene rubber
0.7 pbw peroxide initiator
0.7 pbw 3-Methylacryloxypropyltrimethoxysilane
1 pbw silica filler

This paste was coated onto a 50 μm thick release-coated polyester film and dried at 100° C. for 5 minutes to make Film A, Layer 2 at 25 μm thickness. This film layer was tested for viscosity at 100° C., 120° C., and 150° C. using a parallel plate rheometer with 25 mm diameter, and a dynamic temperature ramp test at 10.0 rad/s and a ramp rate of 5.0° C./min.

The two layers were laminated to one another with a roll laminator at 80° C. and 0.21 MPa, the resulting 2 layer film being Film A. Film A was then laminated to wafers, with Layer 2 being in contact with the wafer, at 50° C. and 0.21 MPa. The laminated wafers were singulated into individual dies of two different sizes and stacked packages of two different configurations (i) and (ii) were constructed.

In configuration (i), 8×8 mm dies were laminated together in a package using a silver plated copper leadframe with 25 μm diameter wires, 80 μm bond pad pitch, and 40 to 70 μm wire loop height. Die attach was performed at 150° C. with 15 N attach force.

In configuration (ii), 7.5×7.5 mm dies were laminated together in a package using a BT substrate with 25 μm diameter wires, 80 μm bond pad pitch, and 50 to 70 μm wire loop height. Die attach was performed at 150° C. with 20 N attach force.

The resulting stacked packages were cross-sectioned and examined for voids around the wires and contact between the second die and the wire bonds of the first die, using optical microscopy.

### Example 2

FILM B. Layer 1 (for adhesion to the first semiconductor chip) was prepared by mixing the following components in parts by weight (pbw) in sufficient MEK to make a paste:
10 pbw epoxy-modified CTBN
3.8 pbw cresol novolac epoxy
0.8 pbw aromatic diamine
0.08 pbw amine catalyst
0.2 pbw silane coupling agent
0.4 pbw silica filler

This paste was coated onto a 50 μm thick release-coated polyester film and dried at 100° C. for 5 minutes to make Film B, Layer 1 at 40 μm thickness. This film layer was tested for viscosity at 100° C., 120° C., and 150° C. using a parallel plate rheometer with 25 mm diameter, and a dynamic temperature ramp test at 10.0 rad/s and a ramp rate of 5.0° C./min.

Layer 2 (for adhesion to the second semiconductor chip) was prepared by mixing the following components in parts by weight (pbw) in sufficient MEK to make a paste:
9 pbw nitrile butadiene rubber with a Mw of 360,000 and a Tg of −24° C.
4 pbw 4,4′-bismaleimido-diphenyl methane
0.7 pbw 3-Methylacryloxypropyltrimethoxysilane
0.4 pbw peroxide initiator
0.3 pbw silica filler

This paste was coated onto a 50 μm thick release-coated polyester film and dried at 100° C. for 5 minutes to make Film B, Layer 2 at 20 μm thickness. This film layer was tested for viscosity at 100 ° C., 120° C., and 150° C. using a parallel plate rheometer with 25 mm diameter, and a dynamic temperature ramp test at 10.0 rad/s and a ramp rate of 5.0° C./min.

The two layers were laminated to one another with a roll laminator at 80° C. and 0.21 MPa, the resulting 2 layer film being Film B. Film B was then laminated to wafers, with Layer 2 being in contact with the wafer, at 50° C. and 0.21 MPa.

The 8.8×10 mm dies were laminated together in a package using a BT substrate with 25 μm diameter wires, 80 μm bond pad pitch, and 42 to 52 μm wire loop height. Die attach was performed at 130° C. with 10 N attach force for one second. The resulting stacked package was cross-sectioned and examined for voids around the wires and contact between the second die and the wire bonds of the first die, using optical microscopy.

### Example 3

FILM C. Layer 1 (for adhesion to the first semiconductor chip) was prepared by mixing the following components in parts by weight (pbw) in sufficient MEK to make a paste:
10 pbw epoxy-modified CTBN
3.8 pbw bis-A epoxy
0.5 pbw aromatic diamine
0.08 pbw amine catalyst
0.2 pbw silane coupling agent
0.4 pbw silica filler

This paste was coated onto a 50 μm thick release-coated polyester film and dried at 100° C. for 5 minutes to make Film C, Layer 1 at 40 μm thickness. This film layer was tested for viscosity at 100° C., 120° C., and 150° C. using a parallel plate rheometer with 25 mm diameter, and a dynamic temperature ramp test at 10.0 rad/s and a ramp rate of 5.0° C./min.

Layer 2 (for adhesion to the second semiconductor chip) was prepared by mixing the following components in parts by weight (pbw) in sufficient MEK to make a paste:
9 pbw nitrile butadiene rubber with a Mw of 360,000 and a Tg of −24° C.
4 pbw 4,4′-bismaleimido-diphenyl methane
0.7 pbw 3-Methylacryloxypropyltrimethoxysilane
0.4 pbw peroxide initiator
0.3 pbw silica filler

This paste was coated onto a 50 μm thick release-coated polyester film and dried at 100° C. for 5 minutes to make Film C, Layer 2 at 20 μm thickness. This film layer was tested for viscosity at 100 ° C., 120° C., and 150° C. using a parallel plate rheometer with 25 mm diameter, and a dynamic temperature ramp test at 10.0 rad/s and a ramp rate of 5.0° C./min.

The two layers were laminated to one another with a roll laminator at 80° C. and 0.21 MPa, the resulting 2 layer film being Film C. Film C was then laminated to wafers, with Layer 2 being in contact with the wafer, at 50° C. and 0.21 MPa.

The 8.8×10 mm dies were laminated together in a package using a BT substrate with 25 μm diameter wires, 80 μm bond pad pitch, and 52 to 62 μm wire loop height. Die attach was performed at 140° C. with 20 N attach force for 2 seconds. The resulting stacked package was cross-sectioned and examined for voids around the wires and contact between the second die and the wire bonds of the first die, using optical microscopy.

### COMPARATIVE EXAMPLE 4

COMPARATIVE FILMS D and E. Comparative films were fabricated using polyimido-based insulation layers. For each of the comparative films Layer 1 (for adhesion to the first semiconductor chip) was prepared as described in Example 1, for Film A.

Layer 2 (for adhesion to the second semiconductor chip) was prepared by mixing the following components in parts by weight (pbw):
Comparative D, Layer 2:
Siltem STM 1500 siloxane polyetherimide resin with a Tg of 168° C. and weight average molecular weight of around 11,000: 30 pbw
Dioxolane solvent: 170 pbw;
Comparative E, Layer 2:
Siltem STM 1500 siloxane polyetherimide resin with a Tg of 168° C. and weight average molecular weight of around 11,000: 30 pbw
Dioxolane solvent: 170 pbw;
Hycar 1300×43 VTBNX vinyl terminated butadiene rubber: 10 pbw
Peroxide initiator: 0.2 pbw.

These pastes were individually coated onto a 50 μm thick release-coated polyester film and dried at 100° C. for 4 minutes to make Comparative Film D, Layer 2 and Comparative Film E, Layer 2 at 25 μm thickness. For each sample, this film layer was tested for viscosity at 100° C., 120° C., and 150° C. using a parallel plate rheometer with 25 mm diameter, and a dynamic temperature ramp test at 10.0 rad/s and a ramp rate of 5.0° C./min.

For each Comparative Film, the two layers (1 and 2) were laminated to one another with a roll laminator at 80° C. and 0.21 MPa, the resulting 2 layer films being Comparative Film-D and Comparative Film-E, respectively. Each comparative film was then laminated to three separate silicon wafers, with Layer 2 being in contact with the wafer, at 0.21 MPa and 50° C., 100° C., and 150° C., respectively. The laminated films were then tested for room temperature peel strength against the wafer with 10 mm wide samples pulled at a 90° angle at 50 mm/min.

Results for Examples 1, 2, 3, and 4 are summarized in TABLES 1, 2 and 3.

TABLE 1
Film Properties for Examples 1, 2, 3, and 4.

| | | Viscosity at | Viscosity at | Viscosity at |
|---|---|---|---|---|
| Film | | 100° C., P | 120° C., P | 150° C., P |
| A | Layer 1 | 8,619 | 3,326 | 831 |
| | Layer 2 | 167,000 | 159,000 | 557,000 |
| B | Layer 1 | 8,619 | 3,326 | 831 |
| | Layer 2 | 101,000 | 95,490 | 59,710 |
| C | Layer 1 | 19,440 | 9,412 | 2,600 |
| | Layer 2 | 101,000 | 95,490 | 59,710 |
| Comparative-D | Layer 1 | 8,619 | 3,326 | 831 |
| | Layer 2 | >1,000,000 | >1,000,000 | >1,000,000 |
| Comparative-E | Layer 1 | 8,619 | 3,326 | 831 |
| | Layer 2 | 7,464 | 6,400 | 5,958 |

TABLE 2
Peel Strength Results for Examples 1, 2, 3, and 4

| | 50° C. | 100° C. | 150° C. |
|---|---|---|---|
| Film | Lamination | Lamination | Lamination |
| A | 2.1 N/cm | (not tested) | (not tested) |
| B | 1.4 N/cm | (not tested) | (not tested) |
| C | 1.3 N/cm | (not tested) | (not tested) |
| Comparative-D | 0 N/cm | 0 N/cm | 0 N/cm |
| Comparative-E | 0.01 N/cm | 0.02 N/cm | 0.2 N/cm |

TABLE 3
Optical Microscopy Results for Examples 1, 2, and 3.

| | | | Wire Touching |
|---|---|---|---|
| Film | Package | Voids Observed | Second Die |
| A | (i) Leadframe | None | No |
| | (ii) BT | None | No |
| B | BT | None | No |
| C | BT | None | No |

The inventive examples all had relatively low viscosity for Layer 1, enabling flow around the wires, with high viscosity of Layer 2 to prevent penetration of the wire through to the second die. Comparative Film E, with the polyimido-based insulation layer, had an extremely high viscosity, which would also prevent penetration of the wire through to the second die. However, as shown in the peel strength results the film could not be laminated to the silicon wafer, even at 150° C. lamination temperatures. Comparative Film F, which was polyimido-based with a small amount of vinyl terminated butadiene added for improved flow and wetting during lamination, had a lower viscosity of the insulation layer. However, Comparative Film F did not achieve appreciable peel strength to the wafer, even at 150° C. lamination temperature. It could be speculated that this film could achieve acceptable peel strength at a higher lamination temperature, possibly above the Tg of the polyimide. However, the dicing tapes typically used are made of polyolefins that start deforming at around 100° C. and this would be unacceptable for manufacturing purposes. Further, laminating at such high temperatures would cause excessive warpage of the wafer, especially if it were very thin.

Stacked packages made from the inventive films all showed the desired properties of good flow around the wires, with no voids observed. Optical microscopy results showed that the wire bonds did not touch the second die, indicating that the insulation layer had prevented penetration during die attach. Packages were not assembled with the comparative films because they could not be laminated to the wafer.

What is claimed:

1. An adhesive film for die stacking at least two neighboring semiconductor dies containing metal wire bonds, the film comprising
(a) Layer-1 adhesive, which comes in contact with the first semiconductor die and is capable of flowing around the metal wire bonds of that first semiconductor die at die attach temperatures, and
(b) Layer-2 adhesive, which comes in contact with the second semiconductor die, in which Layer-2 adhesive comprises 30-85 weight % thermoplastic rubber with a glass transition temperature of less than 25° C. and a weight average molecular weight of greater than 100,000.

2. The adhesive film of claim 1 in which the Layer-1 adhesive comprises
(a) thermoplastic rubber,
(b) thermoset resin,
(c) curing agent, and
(d) filler.

3. The adhesive film of claim 2 in which the Layer-1 adhesive comprises
(a) 30-85 weight % thermoplastic rubber,
(b) 15-70 weight % thermoset resin,
(c) 0.05-40 weight % curing agent, and
(d) 0.1-30 weight % filler.

4. The adhesive film of claim 1, 2, or 3 in which Layer-1 is at least 15 μm thick.

5. The adhesive film of claim 2 or 3 in which the thermoplastic rubber is a carboxy terminated butadiene-nitrile/epoxy adduct.

6. The adhesive film of claim 2 or 3 in which the thermoset resin is an epoxy.

7. The adhesive film of claim 1 in which the Layer-2 adhesive comprises
(a) thermoplastic rubber,
(b) thermoset resin,
(c) curing agent, and
(d) filler.

8. The adhesive film of claim 7 in which the Layer-2 adhesive comprises
(a) 30-85 weight % thermoplastic rubber,
(b) 15-70 weight % thermoset resin,
(c) 0.05-40 weight % curing agent, and
(d) 0.1-30 weight % filler.

9. The adhesive film of claims 7 or 8 in which the thermoplastic rubber is a nitrile butadiene rubber.

10. The adhesive film of claim 7 or 8 in which the thermoset resin is a maleimide.

11. The adhesive film of claim 7 or 8 in which the thermoset resin is a styrenic oligomer.
